(19) United States
(12) Patent Application Publication
(10) Pub. No.: US 2004/0139147 A1
(43) Pub. Date: Jul. 15, 2004

(54) System and method for the dynamic distribution of data and/or services

(76) Inventors: Jonathan Duquenne, La Garenne Colombes (FR); Fabrice Bonan, Paris (FR)

Correspondence Address: OPPEDAHL AND LARSON LLP, P O BOX 5068, DILLON, CO, 80435-5068, US

(21) Appl. No.: 10/475,556

(22) PCT Filed: Apr. 22, 2002
(86) PCT No.: PCT/FR02/01365

(30) Foreign Application Priority Data
Apr. 23, 2001 (FR) 01/05464

(51) Int. Cl. G06F 15/16

(52) U.S. Cl. 709/200

(57) ABSTRACT

The present invention concerns the distribution of applications and services to remote users. It concerns, in particular, the distribution of applications and/or services and, notably, the dynamic distribution of data to remote users connected on all types of networks and architectures distributed. The data are digital assets and will be described below by either of these terms.

This application is the national stage of PCT/FR02/01365 filed Apr. 22, 2002.

### SCOPE OF THE INVENTION

The present invention concerns the distribution of applications and services to remote users. It concerns, in particular, the distribution of applications and/or services and, notably, the dynamic distribution of data to remote users connected on all types of networks and architectures distributed.

The data are digital assets and will be described below by either of these terms.

### TECHNOLOGICAL BACKGROUND OF THE INVENTION

Systems of distribution and/or verification of network data are well known, some of which involve a secure distribution, with a view to obtaining punctual solutions specific for each case.

Thus, patent application WO 00/50995 describes an Internet service integrator consisting of a platform which automatically chooses, integrates and configures, according to the client's requests, the functions necessary for placement of a value-added Internet service.

U.S. Pat. No. 6,075,943 describes a system for the transfer and remote installation of client-server application programs from a source computer in a remote data processing system. A distribution cycle can integrate several programs for different addressees or for one and the same addressee. This system utilizes a decompression program which must be transferred before the compressed application programs to be transferred. Furthermore, the errors are detected, but not handled automatically.

U.S. Pat. No. 6,141,759 describes a system of management of information requests on a computer network. It uses one or more secondary server computer systems, the function of which is to substitute, if necessary, for a first server computer. The errors possibly detected in processing of the information request give rise to a reinitialization of the management process.

U.S. Pat. No. 5,999,741 describes a method of remote installation of a software update, in which the system used selects a communication path for requesting information on the existing version and downloading the software update.

The present invention is aimed at providing remote users, as well as the suppliers with which they are connected, with means of dynamic distribution of applications and services in the form of digital information flows, preferably secure and advantageously with a traceability making it possible, for example, to determine the use of an object and/or to locate an object and, if necessary, to obtain user profiles.

### SUMMARY OF THE INVENTION

The system, means and methods according to the invention are based on a client/server architecture. The invention employs a central or server communication platform (also called Resource Center or IRC), which directs agents capable of sending out data to the final stations or to secondary Resource Centers (server software) (also called wire Resource Centers), serving as relays to such agents, while communications between the central communication platform and/or the secondary resource centers and the users advantageously use a secure protocol.

The system according to the invention involves a modularity and means of traceability which make a tool particularly suitable for dynamic transmissions of data and services. In particular, for suppliers of on-line professional services (NSP, ASP, MSP), it makes possible a positioning on new markets and the development of offers that are original, with exceptional quality of service not accessible to preexisting systems. It improves, in fact, the performance of on line offers of services, assuring:

availability and reliability of the services offered,

security and confidentiality of the data exchanged, and

simplicity of use and accessibility of the services.

The system for the distribution of applications and services to remote users, according to the invention, mainly involves at least one central communication platform (IRC), to which agents are functionally connected, making possible the dissemination of data to final user stations and/or, as an option, wire resource centers set up to serve in turn as relays to said agents.

Communication between the communication platform (called Intoan Resource Center here, or abbreviated as IRC) and its agents advantageously employs a protocol called IVAP as abbreviated (Intoan Versatile Access Protocol), which is a secure protocol elaborated by the applicant.

The invention thus provides a system making it possible to produce and manage flows of digital assets, as well as the information associated with same, advantageously through the set of actors, from creation of the asset to its consumption, with the objective notably of maximizing the value of that asset, as it is perceived by the final client.

The asset created can be of a type pre-existing at the supplier's or be specially created on request.

The invention is described below more in detail, with reference to the attached drawings, which in no way limit it and solely illustrate certain embodiments of the invention.

### BRIEF DESCRIPTION OF THE DRAWINGS

The invention is illustrated below more in detail, with reference to the attached drawings, in which:

FIG. 1 schematically represents the elements constituting the system according to the invention and its environment;

FIG. 2 is a schematic representation of an embodiment of a modular architecture common to the server and to an agent;

FIG. 3 represents an embodiment of the IVAP protocol;

FIG. 4 illustrates the traceability of the digital assets and of the procedures in an example of dynamic distribution according to the invention; and

FIG. 5 shows a sequence diagram example representing the operation of the communication protocol advantageously used according to the invention in a client/server application.

In the attached figures, the same reference numbers are, save for exceptions, used for the same elements appearing on several figures.

### DETAILED DESCRIPTION OF THE INVENTION

Although the terminology used in the present application is standard and/or easily understandable to the expert in the different conceptual, technical and operational fields concerned, the definitions of certain terms are supplied below in order to guarantee their clarity. Some names used in the course hereof are commercial terms belonging to their respective owners.

The primary object of the present invention is a system for the dynamic distribution of data and/or services, involving essentially:

one server (IRC) and possibly wire servers (or wire Resource Centers);

at least one agent, that is, a program support, the latter being able to communicate with the server and/or the wire Resource Center(s) and being capable of becoming a resident on the user's machine;

at least one communication layer capable of carrying calls of remote methods on objects situated on a server and/or on a wire server and of using at least one communication protocol capable of securing an interactive link between a server and agents,

while said protocol contains:

means rendering it capable of producing and managing communications between at least one agent and the IRC, notably through XML messages;

means for calling a remote method by reading/writing of objects of types ObjectRequest and ObjectResponse, respectively, advantageously by means of a stub and a skeleton.

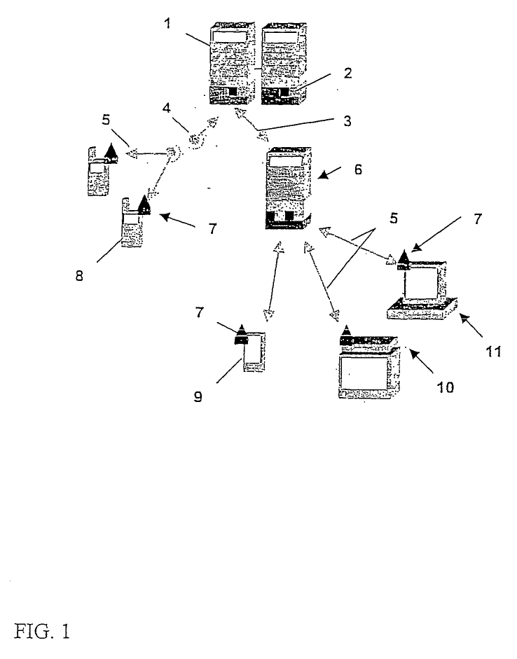

Thus, referring to FIG. 1, an embodiment of the system according to the invention contains a parent IRC server 1, integrating services 2 placed in interactive communication by a wire connection 3 and/or a wireless connection 4, by means of a protocol 5 (IVAP protocol here) with, for example, a wire server 6 and/or at least one agent 7, resident or having become resident on a user terminal such as a telephone 8, a PDA 9, a Set Type Box 10 and/or a computer terminal 11, PC, Mac® or Sun® server or the like., As an option, one or more wire IRC servers 6 can also be present.

The system according to the invention can operate on all types of networks. It advantageously makes possible the secure transport of all types of contents (for example, texts, images, software, video, etc.) to all types of terminals, such as, for example, computers, telephones and digital assistants, among others.

In this system, the server or servers and the agents are built around the same architecture. In that architecture, the base layers integrated in the server as well as in the agents and/or in the wire Resource Centers contain means and/or functionalities appropriate for securing:

communication with the agents (IVAP layer): exchanges of messages and binary exchanges and, as an option,

encryption (by means of an SSL layer, for example), and/or

compression (by means of a Zlib layer, for example), and/or

scheduling of tasks, and/or

access to external databases, and/or

additions/removals of modules, notably.

The base layers are advantageously integrated in a “framework,” which makes possible the dynamic addition of modules.

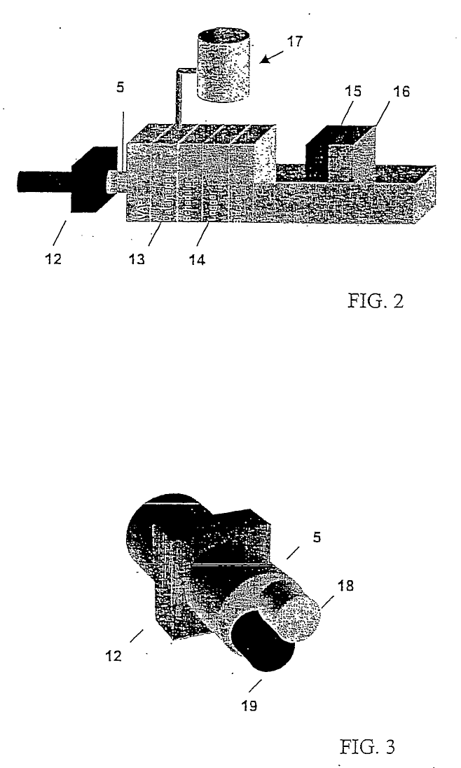

FIG. 2 thus schematically represents a modular architecture, which is common to the server and to the agent, containing an encryption layer 12, a communication layer capable of using an IVAP protocol 5, core modules (or central modules) 13,14, and additional modules 15, 16, each in indefinite number, as well as a database management system 17, the latter being optional for the agent 7 (see FIG. 1).

Said modules are, for example, individually or cumulatively modules of the type aimed at permitting the deployment of applications, machine monitoring, remote maintenance, remote configuration of a computerized work station, remote maintenance of software packages and protection of user data, among other functionalities and/or applications.

The server software, abbreviated IRC in its preferred embodiment, is preferably developed in Java language.

The agent for the operating system of a connected terminal (for example, an agent for Windows®) is preferably implemented in C++. The agent can, however, be developed in any language at all, as a function of the architecture. The expert is capable of inventorying these situations, of analyzing them and of selecting one or more languages appropriate for a defined architecture.

By way of non-limitative example, FIG. 3 illustrates an architecture of protocol elements of a system according to the invention. In this figure, an encryption layer 12 (layer SSL, for example), the IVAP communication protocol 5, an XML channel 18 for the exchange of messages and a binary channel 19 for the exchange of data are schematized.

An agent, as it is understood according to the present invention, is a program support, which can be acquired as is in CD-ROM, DVD or other form, or formatted and loaded from an Internet site, among others, the acquirer choosing the agent corresponding to the architecture of his machine, whether involving a PC, a Mac®, a Palm® or other devices intended to accommodate said agent, and which advantageously contained at least one desired program or on which at least one program can be advantageously registered by downloading or, for example, from a supplier Internet site.

The machine integrating or receiving the program support agent can be either a PC computer or Mac, a personal assistant, a mobile telephone or any similar device.

At the end of its installation, the agent becomes resident on the machine.

In a preferred embodiment, the system can be totally or partially autonomous, dynamic and sophisticated. It can afford the final user real freedom, insofar as that final user does not necessarily have to intervene in the management or maintenance process and can work independent of the system, which operates transparently.

Such a system according to the invention can be used in “large businesses” as well as in very small enterprises or small- and medium-sized businesses.

The system according to the invention is advantageously used according to a method which constitutes another object of the present invention.

The object of the invention is thus also a method for the dynamic distribution of data and/or services, essentially entailing the stages consisting of:

procuring at least one agent, that is, a program support, which can be acquired as is in CD-ROM, DVD or other form, or formatted and loaded from an Internet site, among others. The acquirer chooses the agent corresponding to the architecture of his machine, whether involving a PC, a Mac®, a Palm® or other devices intended to accommodate said agent;

installing such agent, for it to become resident on the user's machine;

subscription of the agent by the user to the services offered, directly from the agent's interface through a directory, for local services (that is, defined on the local Resource Center) as well as for public services, and for both pay services and free services;

as an option, subscription of the agent to the services by the system administrator from the IRC interface (that is, centralized);

registering for those services with, correlatively, automatic loading or downloading of the components necessary for their activation.

Said protocol is intended to optimize the transfers (compression, use of the pass-band and other means) between the IRC and the agents. It can be activated without the speed of the exchanges having to be increased, the latter remaining a function of the quality of the network selected.

In one advantageous embodiment, the method according to the invention uses a protocol, advantageously the above-mentioned IVAP protocol (see FIG. 3), the essential stages of which consist of:

producing and managing communications between at least one agent and the IRC, notably through XML messages;

calling at least one remote method by reading/writing of ObjectRequest and ObjectResponse types, respectively, advantageously by means of a stub and a skeleton.

More precisely, the agent 7 communicates with the IRC 1 through XML messages. The XML communication layer 18 serves most of the time for carrying remote method calls on objects situated on the Resource Center server.

According to a preferred form of operation, the call of a remote method is made by reading/writing of objects, ObjectRequest and ObjectResponse, respectively.

An Object Request encapsulates a method call, that is, it contains:

the name of the remote method (a simple character string) and a list of parameters (that is, of other objects).

An ObjectResponse encapsulates the return state of the remote method, that is, for example:

a return value object,

an exception object (if an exception, raised on execution on the server's side, has to be intercepted by the client),

the object(s) passed by reference to the method whose state must change.

The process of reading/writing of an object in a data flow (network, file, etc.) corresponds to the process of serialization (writing) and deserialization (reading) and makes it possible to render the objects persistent, that is, materializable on a remote platform. The communication by flow of objects recommended according to the invention introduces the level of abstraction necessary for easy processing of the exchanges between client and server. Formalization of the serialization/deserialization processes makes it possible to automate their use, that is, programming.

The remote method call uses what is commonly called a stub and a skeleton. That involves two classes of objects, one on the user station and the other on the server, respectively. The stub and the skeleton are supposed to procure for the client user and server respectively a common multiplatform interface, which delegates the communication services. That interface defines the delegated methods that the client user may wish to call on the server. The data flow (see diagram below of an illustrative XML object in the form of a class diagram) is entirely encapsulated by those two classes.

[image]

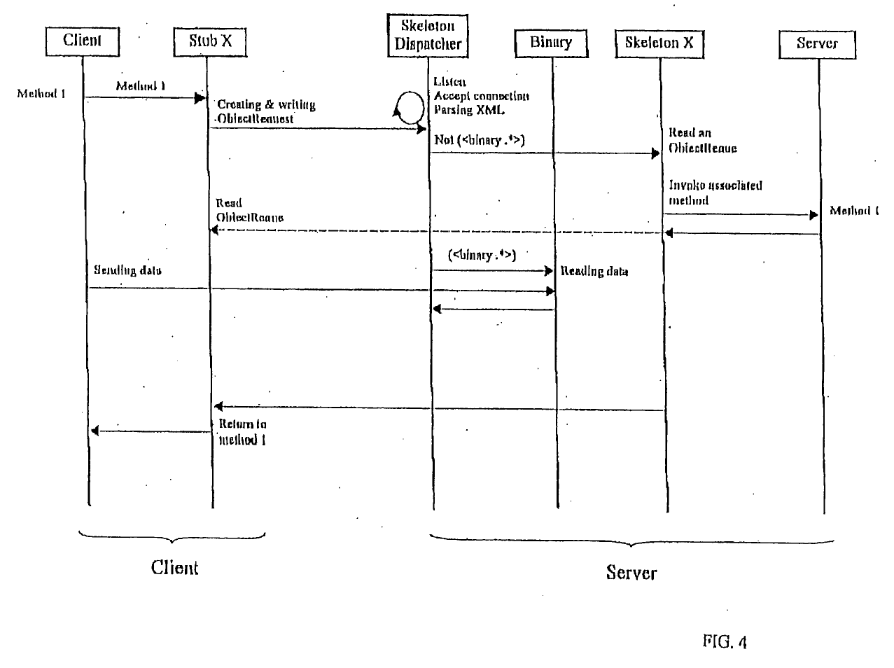

FIG. 4 of the attached drawings represents, in the form of an illustrative and non-limitative sequence diagram, the operation of the stub and skeleton in a client/server application, when the method 1 of the object X interface (see above) is invoked by the client user. The dotted lines represent communication over the network.

It is to be noted that closing of the socket is at the client's initiative, when one or more methods have been called.

By way of example, a user can thus subscribe to a software rental service. The agent used then dialogues with the Intoan Resource Center, which sends it the components associated with at service: distribution of software, removal of software and control. The user can immediately utilize the software loaded. The traceability set in place by the system according to the invention will further supply information linked to its use, such as, for example, its duration of use.

Technically, one thus advantageously employs:

on the one hand, an appropriate protocol, described here by its abbreviation IVAP (Intoan Versatile Access Protocol), which ensures an interactive link comparable to an umbilical cord connecting an IRC and/or wire IRCs to agents, and

on the other, a system ensuring the traceability of the digital assets which are carried by means of that protocol.

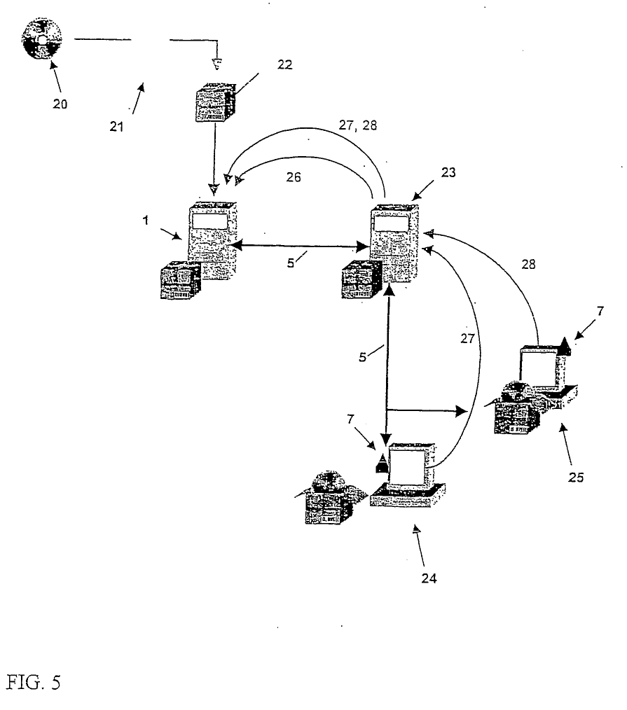

The traceability, as understood according to the invention, is illustrated in FIG. 5, in which a digital asset 20 is packaged or wrapped in a package 22 thanks to an application 21 and provided with an “electronic label,” and then deposited on an IRC 1 and routed according to a protocol 5 to the IRC 23 responsible for the final target stations 24, 25. A reception notice 26 is sent to the sender server. The agents 7 of the final stations, which recover the digital assets, send notices 27, 28 to their IRC.

In practice, the system for use of the said traceability can comprise, by way of example (see FIG. 5):

means for packaging or wrapping a digital asset 20 (such as a software), for example, thanks to the Application Packer for Windows 21;

means for providing the package 22 with a “software electronic label” that can contain, notably, the following elements:

name, size and date of the package,

description of the contents,

electronic certificate, etc.,

means for depositing the package 22 on an IRC 1 and for routing it automatically (thanks here to the IVAP protocol 5) to the IRC 23 responsible for the final target stations 24, 25;

means for the server 23 to send, upon receipt of the package, a notice of receipt 26 (which includes the electronic label of the package, the server's certificate, the time of receipt of the package, etc.) to the sender server 1;

means for recovery of the package 22 by the agents 7 of the final stations and for the dispatch by the agents 7 of notices 27, 28 to their IRC; and

means for the final stations to inform their IRC regularly of the operations they carry out on the digital asset concerned (for example, deletion, launching of software, etc.); and, as an option,

means for the deposit of notices 26, 27, 28 in databases and/or for their automatic ascent to all levels, preferably to the level of the main server 1.

It is to be noted that in this system an agent can be connected to several IRC servers.

In a preferred embodiment, the system for dynamic distribution of data and/or services according to the invention comprises means of traceability consisting essentially of:

an application 21 ensuring the packaging of a digital asset 20 in order to constitute a package 22 and the allocation to the latter of a software electronic label;

means for the deposit of said digital asset on an IRC 1;

means for routing said digital asset according to a protocol 5 to the IRC 23 responsible for the final target stations 24, 25;

means of supply of at least one notice relating to the package 22 and of sending the latter to the sender server 1 and/or 6.

“Notice relating to the package” 22 is understood here to mean a notice of receipt 26 and/or 27, 28 as well as notices of copy, deletion, modification or the like, respectively.

The object of the invention is thus also a system for the dynamic distribution of data and/or services, as described above, and in which distribution is carried out with traceability by means and/or elements of the system, as described above.

In these embodiments, the system integrates a sophisticated engineering making it possible to offer a complete traceability of the digital assets processed by the system. That sophisticated engineering can, notably, involve means designed to provide appropriate markings of files, return codes, routings, etc.

From the standpoint of the method used for its application, traceability, as it is understood according to this invention, includes the following stages:

packaging or wrapping of a digital asset 20 (such as software), for example, thanks to the Application Packer for Windows 21;

supply to the package 22 of a “software electronic label” that can contain notably the following elements:

name, size and date of the package,

description of the contents,

electronic certificate, etc.,

deposit of the package 22 on an IRC 1 and routing of the package 22 automatically (thanks here to the IVAP protocol 5) to the IRC 23 responsible for the final target stations 24, 25;

dispatch by the server 23, upon receipt of the package, of a notice of receipt 26 (which includes the electronic label of the package, the server's certificate, the time of receipt of the package, etc.) to the sender server 1;

use of the package 22 received by the agents 7 of the final stations and dispatch by the agents 7 of notices 27, 28 to their IRC; and

regular information by the final stations to their IRC on the operations they carry out on the digital asset concerned (for example, deletion, launching of software, etc.); and, as an option,

deposit of notices 26, 27, 28 in databases and/or automatic ascent of said notices to all levels, preferably to the level of the main server 1 or of at least a wire server 6.

The object of the invention is thus also a method for the dynamic distribution of data and/or services, as described above, and in which the distribution is carried out with traceability by such means as described above.

Thus, according to the present invention, a platform of interactive distribution of digital assets and services is made, preferably in association with traceability means.

The system and method according to the invention advantageously employ a preferred selection of technical means which have proven capable of optimizing the results. Among all the means on which the selection has been made, the following can be mentioned, by way of purely illustrative and non-limitative examples:

use of object languages. They offer, in particular, the advantage of relying on more structured codes and affording a possibility of reuse of the components employed and easier and more dependable maintenance of software compared to other languages, such as languages of structured type, for example;

choice of an independent development language for the platforms and agents respectively. In fact, it appeared that the differences existing between the roles, functionalities and characteristics of the IRC and agents rendered it possible to tackle the question of a development language independently for each, while striving to maintain a degree of consistency, since those two types of units are intended to communicate with each other.

For the development of the IRC, the choice was focused on the Java language. The latter offers two essential technical advantages:

it is multiplatform, that is, it is oriented to the majority of operating systems currently available;

its components are interoperable and reusable.

For development of the agents, preference was given to the C++ language, but the Java and C languages can also be used, among others. However, it turned out that the different functionalities associated with the client parts of the communication solution according to the invention rendered preferable a different choice of language for development. The use of the Java language would lead to the presence of a Java Virtual Machine on each client station. Furthermore, it is highly advantageous to conceive of programs occupying disk space small enough for them to be installed on all the final stations. Finally, use of the C++ language made possible faster execution of the programs on the final stations.

In order to render operation of the system more dynamic, one can also opt for COM objects, in the case of the Agent for Windows, a choice that can be different for other agents designed for other types of architecture. The use of COM agents makes it possible, in fact, to dynamically add modules to the agents and affords them the capacity to interact with their environment.

In relation to the aforesaid preferred choices recommended for development of the principal actors of the system according to the invention, for communication between the IRC and the agents, the IVAP protocol, which is based on the XML language, is strongly urged. The XML standard language makes it possible to exchange and store data at the level of configuration of the agents, as well as to improve readability of the data and to facilitate the advances desired. The IVAP protocol based on that language, which affords it the said advantageous properties, is a protocol that is both reliable and efficient.

An additional improvement of that system according to the invention, as described below, was made in order to respond better to the considerable increase in the number of solutions now dedicated to data transport, in order to enable the information channeled to benefit easily from high value-added services.

The XML language is ideal for the exchange of messages and has thus become an industry standard in EDI (Electronic Data Interchange). It is, however, relatively ill-suited to data transport: it offers no possibility of compression nor of error recovery.

The use of appropriate standard components and of the IVAP protocol makes it possible to join very high value-added services to the information channeled, by integrating encryption (SSL (Secure Socket Layer) encryption layer), error recovery, operation scheduling and data traceability, among other things.

Such a protocol of communication between the server and the agents, possibly through the wire IRC, is a full-fledged protocol, operating above the TCP/IP protocols. That protocol, advantageously used according to the invention, thus possesses its own IP ports.

This protocol is designed to manage binary flows., transactions and calls of remote procedures. It makes it possible to distribute dynamically, without interruption of existing services and without physical intervention on the platforms and client stations, additional services on all or, as an option, part of the distribution network.

The transport of digital data and associated information by means of the system according to the invention is carried out on the “Digital Logistic Chain” (CLN), also called “Digital Supply Chain.”

In one embodiment, the protocol thus used integrates the management of a binary data exchange channel, which affords it better reliability, notably, in case of interruption of data transfer. That offers the possibility of making error recoveries, for example. Thus, when it is interrupted, the transfer resumes in the precise place where it was interrupted.

This binary flow management is native. It notably enables the protocol to optimize the exchanges, thanks to the optional addition of compression techniques of known type.

In XML language, the communication protocol used is of a sophisticated character, which constitutes an advantage. That affords it the capacity to organize message exchanges in a standard and open manner.

For its protection, a standard security protocol called “Secure Socket Layer” (SSL) can be added to it. In that embodiment, the data transfer/management protocol integrates an SSL encryption layer, which makes it possible to render the messages unreadable during their routing.

The invention will now be described more in detail below, with reference to illustrative embodiments, which in no way limit the invention claimed.

The Server and Agents of the Intoan “Digital Logistic Chain”

The system is based on a client/server architecture. The server is called Intoan Resource Center.

The Intoan Resource Center (or IRC) is the central communication platform of this communication system. It directs agents, which are going to send out the data to the final stations or wire IRCs, which will serve as relay to agents.

Communication between the IRC and its agents is preferably based on a protocol called IVAP (Intoan Versatile Access Protocol), a secure protocol created by Intoan.

I Environment

The IRC-agents nucleus constitutes the core of the system. Those two entities operate in an environment introducing different concepts and different elements. It is advisable, consequently, to define those elements as of now and to specify their position (see FIG. 1).

1 Service

A service is a structured sequence of transactions configured to respond to a particular technical need. It is accommodated by the IRC and consumed by agents. The service can also be relayed by wire IRCs.

The components constituting a service can be personalized by the user. They are organized in a stack, which sequences their execution. The services currently available make it possible, among other things, to monitor stations and applications, to synchronize data for nomad users, to lease applications, to carry out back-up operations, etc.

2 Digital Logistic Chain

The Digital Logistic Chain (CLN) ensures the transport of digital data and associated information between the server and the client stations. It makes it possible to follow the routing of the digital assets, thus establishing a traceability on data transport.

For example, on a subscription to software leasing service, the agent dialogues with the IRC, which send it the components associated with that service: distribution, withdrawal of software and control.

The end-to-end traceability thus set up by the system supplies information linked to the use of that service, like its use time, for example. It makes it possible to introduce transparency in development of the process; it is, for example, possible to locate an application at any given moment and deduce information on network congestion, on the use of resources, on the routing of data, etc. All this information goes back to the Intoan Resource Center on the circulation of digital data, thanks to the integration of sophisticated engineering: marking of files, return codes, routing, etc.

II General Technical Description/Architecture

1 Description

a Intoan Resource Center

The Intoan Resource Center is the server accommodating the services and controlling the agents, possibly through wire IRCs which will serve it as relay, if desired.

b Agent for Windows

The Agent for Windows operates in the client part of the system. It is adapted to the Microsoft Windows® system. It resides on the client stations in order to send out data. It dialogues with the IRC which controls it, its “parent” Resource Center.

Other types of agents operating on other platforms (Mac®, Unix(D, PalmOS®, etc.) can be added to it.

c Communication Protocol: the IVAP

Communication between IRC and agents is ensured by a reliable and preferably secure communication protocol: the Intoan Versatile Access Protocol.

This protocol integrates the XML language, which renders it structured and sophisticated. It manages binary flows, transactions and remote procedure calls.

The secure aspect of the IVAP and, by extension, of all of the transfers made via that protocol is based on the use of a standard secure protocol: the Secure Socket Layer (SSL).

This protocol guarantees private and authenticated communications on the networks. It becomes possible, consequently, to transmit confidential information without risk of it being intercepted by a third party. The two existing principal Web navigators support this protocol.

The SSL operating principle is the use of a private key/public key pair to encrypt the data transferred during the SSL connection.

d Admintool

In addition to its server and client parts, the system according to the invention contains a program designed for the configuration and administration of the IRC: the Admintool. The latter is delivered by default with the solution.

The Admintool (or administration tool) is a program developed in Java, making it possible to configure the IRC from any station at all connected to the network directory or indirectly, by the Internet, for example, and to act on the components installed. That program is connected on the GUI port of the server. The Admintool configures, notably, the following parameters:

the name of the server;

the IP address of the server;

the port intended for the agents;

the administration port;

the administrator password;

the cryptography used (SSL, MD5, etc.);

the location of the certificate files (Keystore and Truststore);

the database connection to be connected.

The Admintool thus renders several components available, in order to optimize operation of the system:

a configuration component of the global parameters of a Resource Center,

an interrogation component of the IRC on its current state (that component is accessible by two distinct implementations: XML version and serialized Java Object version),

an installation and display component of the modules present on the Resource Center,

an installation and display component of the agent licenses on the IRC.

2 Architecture

IRC and Agent for Windows are built around the same architecture. The base layers integrated on both sides make possible:

communication by the IRC with its agents by exchanges of messages and binary exchanges (IVAP layer),

the encryption of those data transfers thanks to an SSL layer,

compression (zlib layer),

scheduling of tasks,

access to external databases,

additions and removals of modules,

etc.

For questions of performance and organization, the Intoan Resource Centers have the power to string them together. It then becomes very simple to deploy an IRC tree structure, each server then being identified and configured automatically. This confers . . . [sic]

Furthermore, the IRC possesses replication (mirroring) and clustering functions making it possible to increase the availability of services and to respond to the large-scale management problems of clients in distributed environments.

a Framework

The system is based on a distributed architecture characterized by its modularity. It is composed, in fact, of a framework and modules.

In that modular architecture, the framework integrates the base layers and makes possible the dynamic addition of modules.

b Modules

A module is a group of task components, integrating a set of services, which makes possible, for example, the deployment of applications, machine monitoring, remote maintenance, remote configuration of a station, remote maintenance of software packages or protection of user data, etc.

Installation of Modules

A module is materialized by a JAR (Java Archive) file, available on CD-ROM or directly on the Internet.

This JAR file contains:

an XML file describing the module,

classes for the components,

DLL libraries for the Agent for Windows,

An SQL script for creating or modifying the tables,

SQL scripts for creating generic services (services offered by default) in the base.

A module is installed via the Admintool, which performs an upload on the Resource Center. The latter then takes charge of storing it correctly on its disk and of validating the license number transmitted at the same time.

There are two categories of modules: the core modules, which are the modules installed by default, and the business modules, which will be installed according to the users' particular needs. The latter can personalize their system themselves, by adding the modules they need.

Core Modules

The core modules are necessary for operation of the system. There are 6 of them: Framework, Subscribe, Identify, File Transfer, Process and Data Recipients.

Framework Module

The Framework module contains the following components:

Scheduler Component

This component makes it possible to program in time call sequences of other components. It is intensively used by the agent for placing calls of transactions and their associated components at regular intervals.

Parser Component

The Parser component integrates coding/decoding functions of the XML language. It accepts on input a data structure of DOM type for generating an XML flow, but creates only XML flows which are integrated in the IVAP protocol.

Insofar as its use is omnipresent in the IRC-agent exchanges, that component is integrated in the Framework module. It is present at the same time in the IRC and in the agent.

Logger Component

Logger reads and writes the XML flows which come to it in a database. This component is on the agent side.

Stacker component

The Stacker components delivers the Business Logic sequences standing by on the Intoan Resource Center for each agent.

A stack is a data structure, consisting of an execution sequence and its parameters, belonging to a service and intended to program an agent according to the service selected.

This component enables the IRC to directly contact an agent in order to ask it to call its stack immediately, which is useful for executing an urgent transaction (immediate deployment of an application on a local station, for example). Furthermore, this component is also responsible for preparation of the stack of agents according to the directives sent by the Admintool.

As far as the agent is concerned, the Stacker component makes possible scheduling of the Business Logic of a transaction in time.

Subscribe Module

This module contains only one component, called Assign Service. Assign Service, installed on both the server side and client side, enables an agent to ask for the list of services offered by a supplier, but also to register an agent in a service of an IRC.

The IRC send the exhaustive list of services it wishes to supply to the agents attached to it.

Identify Module

Like the Subscribe module, that module contains only one component, Identify, which makes it possible to identify the consummation of a transaction by an agent on a Resource Center. Present on the IRC side and on the agent's side, it is generally used at the beginning of each transaction.

The Intoan Resource Center validates the identity of the agent that carries out the transaction and verifies that it is authorized to use that transaction. In the event the agent introducing itself is unknown or is not registered in a service, the IRC does not authorize the transaction. However, if such agent introduces itself in order to be registered in a service, the IRC references it in its database.

On its installation, a new agent creates for itself a single identifier which enables it to be identified in each IRC on which the agent wishes to consume a service.

File Transfer Module

The File Transfer module takes charge of the methods of downloading files with error recovery. Each of the components constituting this module is situated on both the IRC side and the agent side.

Four complementary components constitute this module:

Download Component

This component receives the download requests of the agent. The distinctive feature of the system resides in its operation on error recovery mode; the agent can thus request the download of a file on a specific site.

Upload Component

This component takes charge of the method of upload of files with error recovery. As mentioned in the case of the Download component, the distinctive feature of the system is to operate on error recovery mode, which enables the IRC to ask the agent for upload of a file on a specific site. The component stores the files on the Resource Center according to its local configuration and the parameters transmitted by the agent.

Pack Component

The Pack component groups and compresses files in Intoan.pak format. It accepts an expression as parameter; that expression makes it possible to define the files to be compressed. It is possible to specify options of archiving and compression of the files.

Unpack Component

The Unpack component decompresses pak files, on the basis of the rules of deployment included in the compressed file. These rules concern the deletion and copying of files, file paths, etc.

Process Module

The Process module consists of three components, all situated on the IRC side.

Filter Component

Filter makes it possible to extract properties on a component in order to transmit them to another component.

Format Component

The Format component makes it possible to present or format to another component a character string in which variable entryways are going to be found.

External Connect Component

The role of that component consists of connecting a transaction on an external application. It acts like a system having a client/server architecture, on which the external process is connected. It is, for example, possible, to use External Connect to connect an application deployment transaction to an external billing solution.

Data Recipients Module

As with the Process module, all of the components constituting the Data Recipients module are on the Intoan Resource Center side and are used only in that part of the system.

The Data Recipients module contains 6 components:

Write to Database Component

This component takes charge of the connection on all types of databases.

Write to File Component

Write to File makes it possible to write in a “flat file” a data flow coming from components. This component is useful for establishing LOG type files.

Send Mail Component

Like the Write to Database component, Send Mail makes it possible to write a data flow coming from components in an e-mail and to serid it to its addressee.

Play Sound Component

Within a service, the Play Sound component makes it possible to emit a sound on the IRC in order to signal an event. It is, of course, necessary for the server accommodating the Resource Center to be configured to emit sounds.

Send Snmp Trap Component

Placed within a service, this component makes it possible to send an SNMP trap to a pool management solution in order to set off an alarm on the monitoring console of a third party software.

Write to Ldap Component

The Write to Ldap component takes charge of the connection on an LDAP base (base using the LDAP directory management protocol).

Business Modules

Its modular aspect provides a characteristic peculiar to the system according to the invention, its expandability, insofar as it is possible to add modules to the initial configuration, in accordance with the use of particular client stations; these modules are called business modules.

The agents and the Intoan Resource Center support an unlimited number of modules. Furthermore, the latter are added without the slightest interruption of service being necessary.

In terms of programming, the addition of modules introduces COM objects; the latter make it possible, in fact, to create object instances with libraries.

There are, at present, 4 business modules, to which other specific modules can be added: Application Distribution, Application ASP, Optimail and Assets Sourcer. The components constituting each of those modules are all installed on the IRC side and agent side, thus ensuring communication between the two entities.

Application Distribution Module

The Application Distribution module groups the components and services handling applications deployment and data distribution. It contains two components:

Deploy Applications Component

Deploy Application makes possible the deployment of applications (prepared with the Winpacker) on the stations equipped with an Agent for Windows. On the IRC, it warns the latter of the state of an installation.

Remove Applications Component

Operating on the same principle as the deployment component, Remove Applications carries out the removal of applications on the stations equipped with an Agent for Windows.

Application ASP Module

This module consists of components dedicated respectively to monitoring and billing of the applications used.

Monitor Applications Component

The Monitor Applications component makes possible the monitoring of applications installed by the applications deployment component. It is also responsible for collecting information on the daily use of an application.

Bill Applications Component

This component makes possible the billing of applications installed by the Application Deployer component, as well as that of daily use of an application by a user.

Optimail Module

The Optimail module makes it possible to optimize the management of computer mail. The components constituting that module are complementary.

Read Mailbox Component

This component makes possible the connection of an agent on a computer mail server of POP or IMAP type in order to check the list of waiting messages. The IRC part of that component can check the list of waiting messages in order, for example, to clean up the overly voluminous messages it might contain.

Read Mail Component

Installed on the IRC side, the Read Mail component makes it possible to read the messages selected in the list supplied by the Read Mailbox component.

Store Mail Component

The Store Mail component copies the contents of the message read on the Intoal Resource Center, so that this message will be available outside an Internet connection.

Send Mail Component

Send Mail makes it possible to send a message, thus complementing the Read Mail component.

Clean Mailbox Component

This component makes it possible to clean up the server in a single manipulation. It selects the messages to be deleted according to criteria specified by the user (size of message, date of receipt, etc.).

Assets Sourcer Module

The Assets Sourcer module gathers low-level data concerning the station on which the agent is installed. It consists of two components:

Get Assets List Component

This component collects data on the stations accommodating the agent: type of microprocessor, frequency, disk space, etc.

Store Assets List Component

The Store Assets List component enables the Intoan Resource Center to store the data received by the Get Assets List component.

3 Installation

a Installation of the Resource Center

The Intoan Resource Center is mainly distributed on CD-ROM. Developed in Java, it is designed to operate on platforms that can support a Java Virtual Machine (version 1.3 and higher):

Windows 95, 98, Me, NT 4.0, 2000 (NT and 2000 being recommended),

Solaris SPARC 2.5 and higher versions,

Mac OS 8,0 and higher versions,

HP-UX 10.×, 11.× and higher versions,

AIX 4.× and higher versions,

BSD, Linux Intel, IRIX, Tru64 and other UNIX platforms.

It is also necessary for the server intended to receive the IRC to have a database available prior to installation.

A program installs the components and the libraries of the Intoan Resource Center on the target system.

Depending on the operating system under which the installation program is launched, certain parameters, such as the installation directory under Windows, will be prerecorded. An uninstall program, as well as last-minute documentation, are also copied in the installation directory.

b Installation of Agent for Windows

The installation of Agent for Windows is carried out from an installation program of InstallShield type. Replacement of that program, developed in C++, by the Intoan Technology internal installation system can be envisaged in the future.

The Agent for Windows is installed by default in the “c\Program Files\Intoan\Agent” directory. An uninstall program and recent documentation also appear in that directory.

Once the agent is installed, the Start menu (Programs) gives access to the Intoan Technology file, which contains the following elements:

Intoan Agent, shortened to IAgent.exe (the agent is accompanied by an XML configuration file);

Uninstall (shortened to unwise.exe or other: uninstall program);

Readme file (shortened to last-minute information).

4 Identification

On the first use, the agent verifies that it possesses an identifier (id_agent) in its configuration file. If such is not the case, the agent is going to generate a single identifier by using a key of 50 characters. That key will be valid throughout the life of the agent.

The IP address of the server makes possible the identification connection of the agent, which will transmit its single identifier as well as the common user information (name, given name, address, etc.).

5 Subscription to Services

The server of each provider has a number of services to which the user can subscribe through the agent. Each subscription of an agent to a service consumes a license. Each Intoan Resource Center is sold with a multiservice license for ten agents.

Among the services offered, the services of deployment of applications, synchronization of files and/or directories, data recovery, backup, subscription and cancellation of subscription to other services, etc. are currently available.

The subscription can be made either directly from the agent interface or by a stack directive which will call a subscription transaction. A stack directive describes a line of the stack.

Some services offered for subscription are free, and others are pay services. The information relating to rates is accessible in the presentation page of each service.

a License—Allocation of Licenses

In the course of installation of a module, the user must enter a valid license code.

This code is to be entered in the Admintool interface in the space provided for that purpose.

A license can be collected from a text file (sent by electronic mail, for example). The license code does not exceed 32 characters and does not include any diacritical mark (accents, cedilla, etc.).

License allocation procedure

The user asks for the IP address of the server on which it is desired to install the Intoan Resource Center. An encrypted license is created; it contains the information the IRC needs and is broken down, for example, as follows:

[SERIAL NUMBER|SKU|No. of LICENSES|IP ADDRESS]

At the start and at regular intervals (for example, every hour), the IRC verifies the conformity between its configuration parameters (IP address) and the licenses installed.

b Directory of Services

In order for the agents to subscribe easily to services, they must be able to refer to a main server compiling all the services available. The local services must likewise be compiled in the local directory, so that the agent can subscribe to those services without thereby requiring an Internet. connection.

Two types of directories can therefore be implemented:

Intoan Main Service Directory (IMSD): the Intoan reference directory; in the interface the name of the service is accompanied by the name of the provider supplying that service;

Local Service Directory (LSD): the local director for each IRC.

These two directories are accessible by selection of New Services in the menu of the main screen.

Intoan Main Service Directory

All of the public services are referenced in a global directory. This directory is accommodated and maintained by Intoan. Initially, a single instance of that service will be functional at the world level. It is probable that the IMSD will benefit in the medium term from a high-level material architecture (cluster, mirroring, etc.).

Local Service Directory

Each IRC possesses its own directory, the Local Service Directory. This directory makes it possible to catalogue the private services easily and to render them accessible by the local agents, without having to manage any system of access rights or requiring an Internet connection.

c Registration

By the Agent Interface

Access to the Service Directory makes it possible to subscribe to one or more public or private services (stored locally on the IRC).

By a Stack Directive

The subscription of an agent to a particular service can be carried out by a stack directive (it is then a question of a forced directive), which directive may have been placed in the stack through the GUI port, in order to call a subscription transaction (Register to Service transaction).

d Referencing of a New Service

An Intoan Resource Center can request the referencing of a new service in the global directory.

When a provider defines a new services, it can reference same automatically in that directory. For that purpose, it must define the characteristics of the service to be referenced (notably, by describing it) as well as the type of referencing it wish to carry out (public or private/local).

e Removal of a Service

An IRC can request the removal of a service.

6 IHM of Agent for Windows

A graphic interface of the simple and intuitive Agent for Windows makes it possible to access all of its functionalities.

7 Compression

Compression is aimed at optimizing data transfers in terms of time and at reducing the disk space devoted to receiving applications and programs on client stations. The bookstore used in the agent is zlib. That bookstore is a standard; it is, notably, used in products such as the one known commercially as Winzip.

8 Additional program: Winpacker

Winpacker or Packer for Windows is an independent program, developed in C++, which enables the clients of the system to prepare by themselves the packages intended for dissemination on the stations of their clients. This program forms part of the package-creating “toolkit” intended for the Intoan Resource Centers. It use is both simple and intuitive.

Winpacker makes it possible to create a file, which will carry the extension .pak, grouping all the files of a directory or list. That new .pak file contains the files of the application to be sent out to the agents and is linked to an XML description file. Finally, that group file can be compressed.

III Technical Choices

Among the different options available for developing the platform and the agents according to the invention, it has been chosen to use object languages preferably. They offer, notably, the advantage of more structured codes, of a possibility of reuse of the components and of better software maintenance than other languages, such as languages of structured type, for example.

Considering the differences existing between the roles, functionalities and characteristics of the IRC and the agent, it seemed necessary to tackle the question of a development language independently for each one, while preserving a degree of coherence (communication between those two units).

1 Development of the Intoan Resource Center

The choice of development of the IRC was primarily focused on the Java language. The latter presents, in fact, two principal technical advantages:

It is multiplatform, that is, it fits the majority of operating systems currently available;

Its components are interoperable and reusable.

These properties are necessary from the standpoint of design of a multiplatform such as the IRC, thus rendering the technical choice coherent.

2 Development of Agent for Windows

If Java constitutes the best option within the scope of server side development, the functionalities linked to the client part of the system according to the invention, notably, the Agent for Windows, entail a different choice for its development.

On the one hand, use of the Java language entails the presence of a Java Virtual Machine on each client station. Furthermore, it is necessary to design programs occupying a disk space small enough to be installed on all the final stations. Finally, the use of that language makes possible a more rapid execution of the programs.

From that point of view, the applicant chose to use the C++ language preferably in the development of its agents.

However, other agents may possibly be developed in other languages, depending on the environment for which they are conceived.

Another technical choice aimed at rendering the system more dynamic consists of using COM objects. The use of those objects makes it possible, in fact, to add modules dynamically to Agent for Windows and offers them the capacity to interact with their environment.

3 IRC/Agent Communication

In accordance with the choices made for development of the principal actors of the system, the communication between the IRC and the agent also imposed a technical choice; as previously mentioned, that choice was focused on the XML language. That language serves as a base for the communication protocol Intoan Versatile Access Protocol (IVAP), a protocol created by Intoan.

The standard XML languages makes it possible to exchange and store data in the Agent for Windows configuration, as well as to improve the readability of the data and to facilitate development possibilities.

Thus benefiting from those properties, the IVAP is both an efficient and reliable protocol.

Among the advantages implied by the modularity of the system according to the invention, the following are to be noted:

the addition of one or more modules can be made without the slightest interruption of service:

a theoretically unlimited number of modules can be supported by the agents and servers;

the agents can work autonomously and invisibly;

the integration of the elements of the system makes it possible to respond to a set of problems with a same set of elements;

all types of connections (for example, by modem, cable, xDSL and specialized link, among others) and all outputs can be supported by the elements of the system.

As for the traceability rendered possible by this method, it enables an exceptional transparency to be introduced on the development of any process employing the system according to the invention.

1. System for the dynamic distribution of data and/or services, characterized in that it involving contains:
one server (1) and possibly wire servers (6);
at least one agent (7), resident or capable of becoming a resident on a user terminal and capable of communicating with the server (1) and/or at least one wire server software (6) and;
at least one communication layer (18) capable of carrying calls of remote methods on objects situated on a server (1) and/or on a wire server (6) and of using at least one communication protocol (5) capable of securing an interactive link between a server (1, 6) and agents (7),
while said protocol contains:
means rendering it capable of producing and managing communications between at least one agent and the IRC, notably through XML messages;
means for calling a remote method by reading/writing of types ObjectRequest and ObjectResponse respectively.

2. System according to claim 1, characterized in that the server or servers and the agents are constructed according to the same architecture, on the basis of a “framework”, completed by optional dynamic additions of modules.

3. System according to claim 3, characterized in that the base layers integrated in the server and in the agents and/or in the wire servers contain means appropriate for securing:
communication with the agents, for exchanges of messages and binary exchanges and, as an option,
encryption, and/or
compression, and/or
scheduling of tasks, and/or
access to external databases, and/or
additions/removals of modules.

4. System according to any one of claims 1 to 3, characterized in that it comprises:
means for packaging or wrapping a digital asset (20);
means for providing the package (22) with a “software electronic label” that can contain, notably, the following elements:
name, size and date of the package,
description of contents,
electronic certificate, etc.,
means for depositing the package (22) on an IRC (1) and for routing it automatically to the IRC (23) responsible for the final target stations (24, 25);
means for the server (23) to send, upon receipt of the package, a notice of receipt (26) to the sender server (1);
means for recovery of the package (22) by the agents (7) of the final stations and for the dispatch by the agents (7) of notices (27, 28) to their IRC; and
means for the final stations to inform their IRC regularly of the operations they carry out on the digital asset; and, as an option,
means for the deposit of notices (26, 27, 28) in databases and/or for their automatic ascent to all levels, preferably to the level of the main server (1) or at least of a wire server (6).

5. System for dynamic distribution of data and/or services according to any one of claims 1 to 3, characterized in that it comprises means of traceability consisting essentially of:
an application (21) ensuring the packaging of a digital asset (20) in order to constitute a package (22) and the allocation to the latter of a software electronic label;
means for the deposit of said digital asset on an IRC (1);
means for routing said digital asset according to a protocol (5) to the IRC (23) responsible for the final target stations (24, 25);
means of supply of at least one notice relating to the package (22) and of sending the latter to the sender server (1, 6).

6. System according to claim 5, characterized in that it contains means for the dispatch of notices (27, 28) by the agents (7) of the final stations, which use the package received (22), to their IRC.

7. System according to one of claims 2 or 3, characterized in that the modules are chosen among modules of the type aimed at permitting the deployment of applications, machine monitoring, remote maintenance, remote configuration of a computerized work station, remote maintenance of software packages and/or protection of user data.

8. System according to any one of claims 1 to 7, characterized in that the server software is in Java language.

9. System according to any one of claims 1 to 8, characterized in that implementation of the agent for the operating system of a connected terminal is carried out in Java, C or C++ language.

10. Method for the dynamic distribution of data and/or services, characterized in that it essentially entails the stages consisting of:
procuring at least one agent, that is, a program support, which can be acquired as is or formatted and loaded from an Internet site;
installing such agent, for it to become resident on the user's machine;
subscription by the user to the services offered by a server (IRC) and/or wire servers, directly from the agent's interface, as well as for public services and for both pay services and free services;
registering for those services with, correlatively, automatic loading or downloading of the components necessary for their activation, and
as an option, integration by forced services supplied automatically.

11. Method according to claim 10, characterized in that it uses a protocol, the essential stages of which consist of:
producing and managing communications between at least one agent and the server and/or a wire server, notably through XML messages;
calling at least one remote method by reading/writing of objects of ObjectRequest and ObjectResponse types, respectively, advantageously by means of a stub and a skeleton.

12. Method according to one of claims 10 or 11, characterized in that it embraces the following stages:
packaging or wrapping of a digital asset (20);
supply to the package (22) of a “software electronic label” that can contain, notably, the following elements:
name, size and date of the package,
description of the contents,
electronic certificate, etc.,
deposit of the package (22) on an IRC (1) and routing of the package (22) automatically to the IRC (23) responsible for the final target stations (24, 25);
dispatch by the server (23), upon receipt of the package, of a notice of receipt (26) to the sender server (1);
use of the package (22) received by the agents (7) of the final stations and dispatch by the agents (7) of notices (27, 28) to their IRC; and
regular report by the final stations to their IRC of the operations they carry out on the digital asset; and, as an option,
deposit of notices (26, 27, 28) in databases and/or automatic ascent of said notices to all levels, preferably to the level of the main server (1) or at least of a wire server (6).

13. Method according to claim 12, characterized in that it further includes the stages whereby:
the final stations inform their IRC (1, 6) of the operations they carry out on the digital asset (20), and/or
the notices are deposited in databases and automatically raised to all levels, preferably to the level of the main server (1) and/or of at least a wire server (6).

14. Use of the system, according to any one of claims 1 to 9, for the distribution of applications and/or services to remote users connected on all types of networks and architectures distributed, notably, for the deployment of applications, machine monitoring, remote maintenance, remote configuration of a computerized work station, remote maintenance of software packages and/or protection of user data.

15. Use of the method, according to any one of claims 10 to 13, for the distribution of applications and/or services to remote users connected on all types of networks and architectures distributed, notably, for the deployment of applications, machine monitoring, remote maintenance, remote configuration of a computerized work station, remote maintenance of software packages and/or protection of user data.
